(19) United States
(12) Patent Application Publication
(10) Pub. No.: US 2025/0353363 A1
(43) Pub. Date: Nov. 20, 2025

(54) FLUSH DOOR FOR VEHICLE WITH RAIL INTEGRATED DOOR FRAME AND METHOD OF ASSEMBLING THE SAME

(71) Applicants: Hyundai Motor Company, Seoul (KR); Kia Corporation, Seoul (KR); SUNG WOO HITECH CO., LTD, Busan (KR)

(72) Inventors: Jea-Hong Kim, Hwaseong-si (KR); Yong-Hyun Nam, Hwaseong-si (KR); Seung Il Choi, Hwaseong-si (KR); Sang-Hyun Na, Hwaseong-si (KR)

(21) Appl. No.: 18/952,258

(22) Filed: Nov. 19, 2024

(30) Foreign Application Priority Data
May 14, 2024 (KR) 10-2024-0063147

(51) Int. Cl. B60J 5/04; B60J 1/17; B60J 10/76

(52) U.S. Cl. CPC B60J 5/0402; B60J 1/17; B60J 10/76

(57) ABSTRACT

An embodiment flush door for a vehicle with a rail integrated door frame includes a door frame of the vehicle, a door glass whose upward and downward movements are guided by the door frame, a garnish plate fastened to the door frame and configured to guide the upward and downward movements of the door glass together with the door frame, and a slider fixed to an end portion of the door glass and configured to move up and down between the door frame and the garnish plate.

### CROSS-REFERENCE TO RELATED APPLICATIONS

This application claims the benefit of Korean Patent Application No. 10-2024-0063147, filed on May 14, 2024, which application is hereby incorporated herein by reference in its entirety.

### TECHNICAL FIELD

The present disclosure relates to a flush door for a vehicle with a rail integrated door frame and a method of assembling the same.

### BACKGROUND

A door glass is installed on doors 110F and 110R of a vehicle 100 for lighting and ventilation of a vehicle.

Among vehicles, as shown in FIG. 1, there is an example in which a door glass 121 is installed without a step between a door glass 121 and a garnish 127. On line A-A in FIG. 1, the door glass 121 and the garnish 127 are installed on the same surface without any step.

The door glass 121 may have a cross-sectional structure as shown in FIG. 2. FIG. 2 is a cross-sectional view of a rear end side of a front door 110F of the front door 110F and a rear door 110R. A space in which a glass run is installed is formed inside a door frame 113. The glass run is provided as a glass run inner lip 124a supporting an inner surface of the door glass 121 and a glass run outer lip 124b supporting an end portion of the door glass 121 and is fastened to a space formed inside the door frame 113. At the end portion of the door glass 121, a slider 122 is attached to the inner surface of the door glass 121. The slider 122 guides the upward and downward movements of the door glass 121 while moving in a height direction of the vehicle 100 inside the rail 114 separately formed on the door frame 113.

The garnish 127 that finishes an outer surface of the door frame 113 is fastened to the outside of the door frame 113. An interior side of the door frame 113 is provided with an inner panel 111, and a door trim is mounted on the inner panel 111 to finish the inner panel 111.

When the door glass 121 is installed on the door frame 113, the slider 122 is attached to the inner surface of the door glass 121, and an end portion of the slider 122 slides in the door frame 113 so that the door glass 121 and the garnish 127 are located at the same height, that is, the same surface without any step.

Since there is no step between the door glass 121 and the garnish 127, there are advantages in that the appearance of the vehicle is improved and noise due to the step is not generated while traveling.

However, in the door 110F, the rail 114 that guides the upward and downward movements of the door glass 121 is applied to the door frame 113 as a separate structure, or although not shown in the drawing, a separate rail is fastened to allow the rail 114 to restrain the perimeter of the slider 122, thereby guiding the upward and downward movements of the slider 122.

However, as such a structure has the rail 114 for guiding the upward and downward movements of the slider 122 applied as a separate structure, there is a problem that assembly is not easy. For example, when the rail 114 is formed integrally with the door frame 113, the rail 114 should be manipulated in a vertical direction of the door glass 121 to which the slider 122 is attached, and thus assembly is not easy.

In addition, due to a space of the rail 114 inside the door frame 113, a component for reinforcing the rigidity of the door 110F is not easily applied.

### SUMMARY

The present disclosure relates to a flush door for a vehicle with a rail integrated door frame and a method of assembling the same. Particular embodiments relate to a flush door for a vehicle with a rail integrated door frame in which the door frame directly guides the upward and downward movements of a door glass and a method of assembling the same.

Embodiments of the present disclosure can solve problems in the art and provide a flush door for a vehicle with a rail integrated door frame, which has a structure that guides the upward and downward movements of a slider attached to a door glass to prevent the application of the rail to the door frame, and a method of assembling the same.

Embodiments of the present disclosure also provide a flush door for a vehicle with a rail integrated door frame, in which a separate structure for rigidity is applied inside a door frame, and a method of assembling the same.

A flush door for a vehicle with a rail integrated door frame according to embodiments of the present disclosure includes a door frame of the vehicle, a door glass whose upward and downward movements are guided by the door frame, a garnish plate fastened to the door frame and guiding the upward and downward movements of the door glass together with the door frame, and a slider fixed to an end portion of the door glass and moving up and down between the door frame and the garnish plate.

An inner guide configured to accommodate the slider may be formed on the door frame.

The inner guide may be formed concavely toward the inside of the vehicle, and the slider is accommodated therein, an outer guide configured to cover the slider accommodated in the inner guide may be formed on the garnish plate, and the outer guide and the inner guide may restrict the movement of the slider in a horizontal direction.

The slider may include a body portion configured to move up and down in a height direction of the vehicle between the inner guide and the outer guide, and a connection portion having one end fixed to the door glass and the other end fixed to the body portion to connect the door glass with the body portion.

A locking portion formed convexly outward of the vehicle and restricting the movement of the slider in a longitudinal direction of the vehicle may be formed on the door frame.

A tension portion configured to elastically support the slider between the slider and the door frame when the slider moves up or down may be formed.

The tension portion may include a first tension portion formed to protrude from the body portion in a width direction of the vehicle to elastically support the body portion in the width direction and a second tension portion formed to protrude from the body portion in the longitudinal direction of the vehicle to elastically support the body portion in the longitudinal direction.

An inner panel may be provided inside the vehicle on the door frame.

The flush door may further include a vertical beam formed between the door frame and the inner panel in a vertical direction of the vehicle.

The vertical beam may be disposed between a portion in which a locking portion configured to restrict movements of the inner guide configured to accommodate the slider and the slider in the longitudinal direction of the vehicle is formed of the door frame and the inner panel.

The vertical beam may be formed to be hollow therein.

The flush door may further include an inner cover fixed to an inside of the vehicle in the inner panel and a weather strip fixed to the inner panel and sealing a gap between the door and another door disposed in the longitudinal direction of the vehicle.

An entry portion formed in a ring shape may be formed at upper and lower ends of the slider in a height direction of the vehicle.

The flush door may further include a garnish cover fastened to an outer surface of the garnish plate and forming a continuous surface with the door glass.

The flush door may further include a glass run inner lip fixed to an end portion of the door frame and sealing a gap between the door frame and the door glass and a glass run outer lip fixed to an end portion of the garnish plate and sealing a gap between end portions of the garnish plate and the door glass.

The flush door may further include an inner cover fixed to an inside of the vehicle in the door frame and a weather strip fixed to the inner cover and sealing a gap between the door and another door disposed in the longitudinal direction of the vehicle.

Meanwhile, a method of assembling a flush door for a vehicle with a rail integrated door frame according to embodiments of the present disclosure includes a door panel temporary assembling operation of assembling a primary door panel assembly by arranging a vertical beam between a door frame and an inner panel and fastening the door frame, the vertical beam, and the inner panel, a door panel assembly completing operation of completing a door panel assembly by assembling the door outer panel outside the primary door panel assembly, a door glass mounting operation of mounting a door glass so that a slider mounted on the door glass is seated on an inner guide formed on the door frame, and a garnish assembling operation of assembling the door frame to a garnish assembly to cover an outside of the slider.

The door glass mounting operation and the garnish assembling operation may each include assembling the door glass and the garnish assembly in a width direction of the vehicle.

The method may further include a glass run mounting operation of mounting a glass run inner lip to the door panel assembly between the door panel assembly completing operation and the door glass mounting operation.

According to the flush door for a vehicle with the rail integrated door frame, which has the above structure, and the method of assembling the same according to embodiments of the present disclosure, by restraining the perimeter of the slider mounted on the door glass by the space formed between the door frame and the garnish plate rather than the separate rail, to guide the upward and downward movements of the slider, the slider can be easily assembled. When the rail is applied, the slider should be assembled in the vertical direction, but when the rail is formed to surround the perimeter of the slider between the door frame and the garnish plate, the door can be assembled only in the width direction of the vehicle, and thus assembly can be easy.

In addition, since the rail is not applied, the internal space is larger, and the vertical beam formed in the vertical direction can be mounted in the space, thereby increasing rigidity.

### BRIEF DESCRIPTION OF THE DRAWINGS

FIG. 1 is a schematic diagram of a vehicle to which a flush door for a vehicle according to the related art is applied.

FIG. 2 is a cross-sectional view along line I-I in FIG. 1.

FIG. 3 is an exploded perspective view showing a flush door for a vehicle with a rail integrated door frame according to embodiments of the present disclosure.

FIG. 4 is a cross-sectional view of the main part of the flush door for a vehicle with the rail integrated door frame according to embodiments of the present disclosure.

FIG. 5 is an enlarged view of portion B in FIG. 4.

FIGS. 6 and 7 are front and side views showing a portion in which a slider is mounted on the flush door for a vehicle with the rail integrated door frame according to embodiments of the present disclosure.

FIG. 8 is an exploded perspective view showing the assembly relationship between the door frame and a garnish in the flush door for a vehicle with the rail integrated door frame according to embodiments of the present disclosure.

FIG. 9 is a cross-sectional view of the main part of a flush door for a vehicle with a rail integrated door frame according to another embodiment of the present disclosure.

FIG. 10 is a flowchart showing a method of assembling the flush door for a vehicle with the rail integrated door frame according to embodiments of the present disclosure.

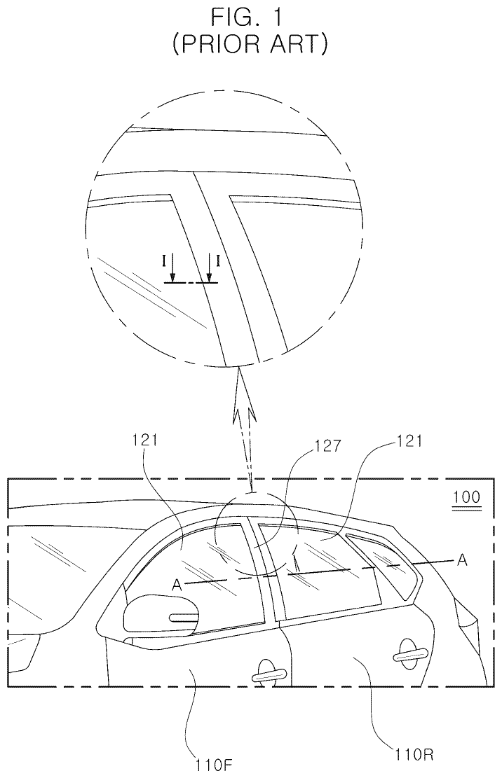

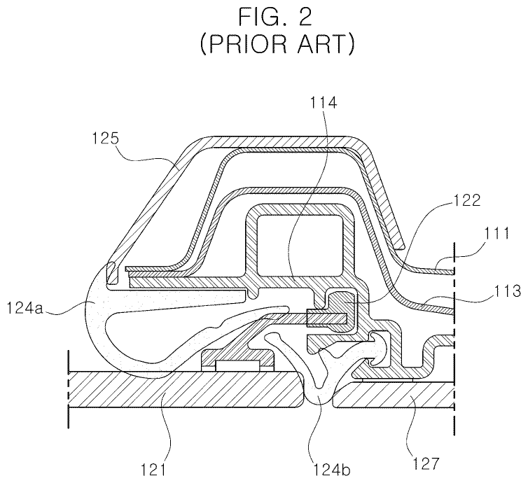

### DETAILED DESCRIPTION OF ILLUSTRATIVE EMBODIMENTS

Hereinafter, a flush door for a vehicle with a rail integrated door frame and a method of assembling the same according to embodiments of the present disclosure will be described in detail with reference to the accompanying drawings.

A flush door 1 for a vehicle with a rail integrated door frame according to embodiments of the present disclosure includes a door frame 13 for a vehicle, a door glass 21 whose upward and downward movements are guided by the door frame 13, a garnish plate 28 fastened to the door frame 13 and guiding the upward and downward movements of the door glass 21 together with the door frame 13, and a slider 22 fixed to an end portion of the door glass 21 and moving up and down between the door frame 13 and the garnish plate 28.

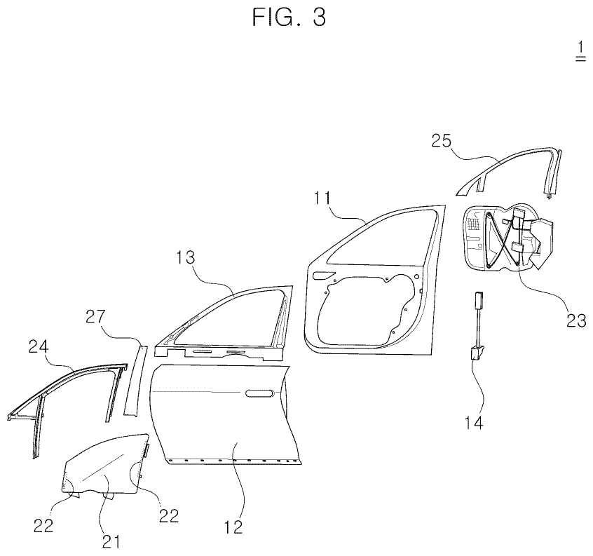

FIG. 3 shows an exploded perspective view of a flush door (hereinafter referred to as “door”) for a vehicle according to embodiments of the present disclosure.

The door frame 13 forms the basic shape of the door 1. Components to be described below are mounted on the door frame 13 to form the door 1.

An inner panel 11 and an outer panel 12 are fastened to the door frame 13 inside and outside the vehicle, respectively.

The door glass 21 is installed to move up and down on the door 1 for lighting and ventilation. The door glass 21 is installed to move up and down on the door frame 13.

The glass run 24 is installed to support the perimeter of the door glass 21 and seal the perimeter of the door glass 21. The glass run 24 includes a glass run inner lip 24a and a glass run outer lip 24b. The glass run inner lip 24a is fixed to an end portion of the door frame 13 and seals a gap between the door frame 13 and the door glass 21. The glass run outer lip 24b is fixed to an end portion of the garnish plate 28 and seals a gap between the end portions of the garnish plate 28 and the door glass 21.

A garnish assembly 27 finishes the perimeter of the door glass 21 in the door 1. The garnish assembly 27 includes the garnish plate 28 and a garnish cover 29. The garnish cover 29 is fastened to the garnish plate 28. In particular, the garnish cover 29 forms a continuous surface with the door glass 21 without any step to form the flush door 1. The garnish assembly 27 is mounted on the door frame 13 by allowing an insert bolt 28b formed on the garnish plate 28 to pass through the door frame 13 and then fastening a fastening nut 28c to the insert bolt 28b.

The inner panel 11 is provided with a door module 23 in which a regulator for moving the door glass 21 up and down, a speaker, etc. are installed.

In addition, an inner cover 25 is mounted inside the inner panel 11 to finish the inside of the door 1. In the door 1, a trim is mounted on the door module 23 to finish the door module 23. A weather strip 26 for sealing a gap between the door 1 and another door disposed in a longitudinal direction of the vehicle is mounted on the inner cover 25. For example, when the door 1 is the front door 1, the weather strip 26 for sealing the gap between the front door 1 and a rear door is mounted on the inner cover 25.

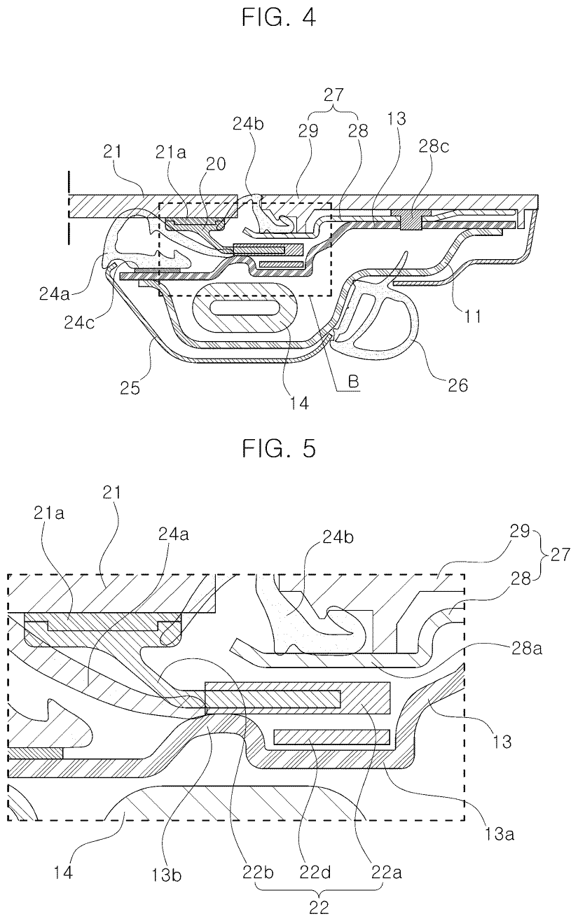

FIGS. 4 and 5 are cross-sectional views of the door 1, for example, showing a B-pillar part of the front door of a vehicle.

The door glass 21 is moved up and down by an operation of the regulator installed on the door module 23, and the upward and downward movements of the end portion of the door glass 21 in the longitudinal direction of the vehicle are guided by the door frame 13.

Meanwhile, in order for the door glass 21 to form a continuous surface without any step with the garnish cover 29, by installing the slider 22 on the end portion of the door glass 21 in the longitudinal direction of the vehicle and guiding the slider 22, the upward and downward movements of the door glass 21 are guided.

When the door glass 21 moves up or down, a structure for guiding the upward and downward movements of the door glass 21 should be applied to the door 1. In the related art, the rail for guiding the upward and downward movements of the slider 22 is applied, but in embodiments of the present disclosure, the structure for guiding the upward and downward movements of the slider 22 is formed directly on the door frame 13 to simplify the structure.

To this end, an inner guide 13a for accommodating the slider 22 is formed on the door frame 13. The inner guide 13a is formed concavely toward the inside of the vehicle to form a space so that the slider 22 is accommodated therein. Since the inner guide 13a serves as the rail of the related art, a rail structure is applied to the door frame 13.

Here, since the inner guide 13a alone may not surround the slider 22, the garnish plate 28 surrounds one side of the slider 22. That is, an outer guide 28a for covering the outside of the vehicle in the slider 22 is formed on the garnish plate 28, and the outer guide 28a is formed to surround the perimeter of the slider 22 together with the inner guide 13a.

Since three surfaces of the slider 22 are surrounded by the inner guide 13a and the outer guide 28a, the movement of the slider 22 in the longitudinal direction of the vehicle is restricted, and the upward and downward movements of the slider 22 are possible by the inner guide 13a and the outer guide 28a.

The slider 22 includes a body portion 22a and a connection portion 22b. The body portion 22a is surrounded by the inner guide 13a and the outer guide 28a and moving up and down in a height direction of the vehicle. The connection portion 22b is for connecting the door glass 21 with the slider 22. The inner guide 13a and the outer guide 28a surround the body portion 22a in a shape in which a U shape is rotated at 90 degrees. That is, since the body portion 22a is surrounded by three surfaces excluding a surface connected to the connection portion 22b, the body portion 22a is located inside a U-shaped space.

The body portion 22a is in a state of only moving up and down in a state in which the movement in the longitudinal direction of the vehicle is restricted between the inner guide 13a and the outer guide 28a.

The connection portion 22b is fixed to one side of the door glass 21 with a sealant 21a. To form the continuous surface of the door glass 21 with the garnish cover 29 without any step, the slider 22 is applied, and the slider 22 is fixed to the door glass 21 through the connection portion 22b.

A locking portion 13b for restricting the movement of the slider 22 in the longitudinal direction of the vehicle is formed on the door frame 13. The locking portion 13b is formed convexly outward of the vehicle, thereby preventing the slider 22 from being separated from the inner guide 13a.

Meanwhile, to prevent noise from being generated when the slider 22 moves up and down, an entry portion 22c is formed at each of the upper and lower ends of the slider 22 (see FIG. 7). The entry portion 22c is formed in an oval ring shape at the upper and lower ends of the body portion 22a, thereby preventing noise generated by the entry portion 22c that is deformed to allow the body portion 22a to be in contact with the inner guide 13a or the outer guide 28a.

In addition, tension portions 22d and 22e for elastically supporting the slider 22 between the slider 22 and the door frame 13 when the slider moves up and down are formed on the body portion 22a. The tension portions 22d and 22e are formed to protrude from the body portion 22a and are elastically supported by the inner guide 13a, thereby absorbing distribution between the body portion 22a and the inner guide 13a. That is, a gap between the body portion 22a and the inner guide 13a is inevitably generated by assembly margin or assembly error in the manufacturing and assembly processes. However, even when assembly margin or assembly error occur due to the tension portions 22d and 22e, the body portion 22a is elastically supported inside the inner guide 13a, thereby preventing the occurrence of the influence due to distribution, such as looseness or tightness.

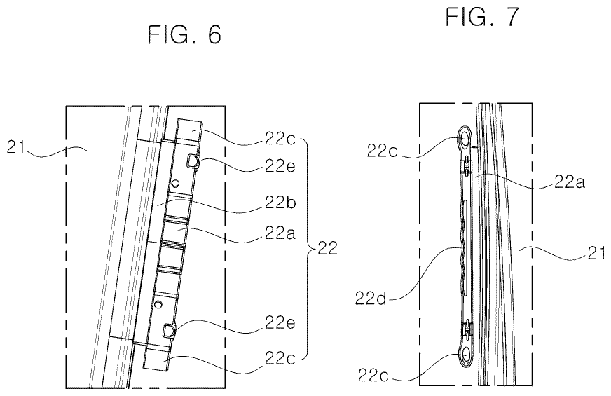

The tension portions 22d and 22e include the first tension portion 22d and the second tension portion 22e. The first tension portion 22d is formed to protrude from the body portion 22a in the width direction of the vehicle and elastically supports the body portion in the width direction (see FIG. 7). The second tension portion 22e is formed to protrude from the body portion 22a in the longitudinal direction of the vehicle and elastically supports the body portion 22a in the longitudinal direction (see FIG. 6).

The first tension portion 22d may absorb the distribution in the width direction of the vehicle, and the second tension portion 22e may absorb the distribution in the longitudinal direction of the vehicle. Referring to FIG. 5, the first tension portion 22d elastically supports the body portion 22a with respect to the inner guide 13a between the body portion 22a and the inner guide 13a, and thus absorbs the distribution between the body portion 22a and the inner guide 13a. Likewise, the second tension portion 22e absorbs the distribution in the width direction of the vehicle.

Grease may be applied between the slider 22 and the door frame 13, that is, between the body portion 22a and the inner guide 13a to reduce friction.

In embodiments of the present disclosure, since the upward and downward movements of the slider 22 are guided by the door frame 13 and the garnish plate 28 instead of the rail, a space is formed between the door frame 13 and the inner panel 11. Here, a vertical beam 14 is applied to reinforce the rigidity of the door 1.

The inside of the vertical beam 14 is formed to be hollow therein and is mounted between the door frame 13 and the inner panel 11 in the height direction of the vehicle.

The vertical beam 14 is formed integrally with the door frame 13 and the inner panel 11. The vertical beam 14 is integrated with the door frame 13 and the inner panel 11 by welding when a body in white (BIW) of the door 1 is manufactured. Thereafter, the outer panel 12 is bonded to the outside of the door frame 13 by hemming and welding to form a door panel assembly. After the glass run 24, for example, the glass run inner lip 24a, is assembled by using a tape 24c, the door glass 21 is mounted. Since the garnish assembly 27 is not mounted until the door glass 21 is mounted, the inner guide 13a is in a state of being opened outward in the width direction of the vehicle. Therefore, the door glass 21 may be easily mounted by allowing the body portion 22a of the slider 22 to be seated inside the inner guide 13a in the width direction of the vehicle.

Thereafter, the door 1 is completed by assembling the garnish assembly 27 and the glass run outer lip 24b.

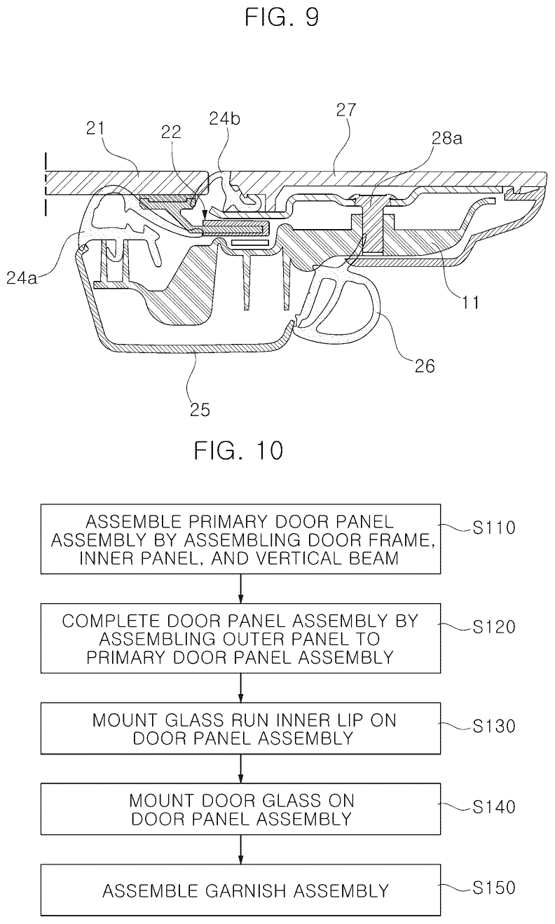

FIG. 9 shows a flush door for a vehicle with a rail integrated door frame according to another embodiment of the present disclosure.

The present embodiment has basically the same structure as the above-described embodiment.

However, in the present embodiment, the door frame 13 and the inner panel 11 are formed integrally. Therefore, the inner cover 25 is fixed to the inner surface of the door frame 13, that is, a surface of the door frame 13 facing the inside of the vehicle, thereby finishing the door frame 13.

Meanwhile, the weather strip 26 for sealing the gap between the door and another door disposed in the longitudinal direction of the vehicle is fixed to the inner cover 25.

FIG. 10 shows a method of assembling the flush door for a vehicle with the rail integrated door frame according to embodiments of the present disclosure.

The method of assembling the flush door for a vehicle with the rail integrated door frame according to embodiments of the present disclosure includes a door panel temporary assembling operation (Silo) of assembling a primary door panel assembly by arranging the vertical beam 14 between the door frame 13 and the inner panel 11 and fastening the door frame 13, the vertical beam 14, and the inner panel 11, a door panel assembling completing operation (S120) of completing the door panel assembly by assembling the door outer panel 12 outside the primary door panel assembly, a door glass mounting operation (S140) of mounting the door glass 21 so that the slider 22 mounted on the door glass 21 is seated on the inner guide 13a formed on the door frame 13, and a garnish assembling operation (S150) of assembling the garnish assembly 27 to the door frame 13 so that the outside of the slider 22 is covered.

The door panel temporary assembling operation (Silo) includes assembling the primary door panel assembly by assembling some components of the door panel assembly. In the door panel temporary assembling operation (Silo), the vertical beam 14 is disposed between the door frame 13 and the inner panel 11, and the door frame 13, the vertical beam 14, and the inner panel 11 are welded to integrate the door frame 13, the vertical beam 14, and the inner panel 11. The vertical beam 14 is located between the door frame 13 and the inner panel 11, thereby improving the door 1.

The door panel assembly finishing operation (S120) includes completing the door panel assembly by assembling the door outer panel 12 outside the primary door panel assembly. The door outer panel 12 is disposed on the primary door panel assembly, and the door panel assembly is completed by hemming and welding. The door panel assembly becomes a door BIW.

The glass run mounting operation (S130) includes mounting the glass run 24, for example, the glass run inner lip 24a, on the door panel assembly. The door frame 13 is attached to the glass run inner lip 24a so that the glass run inner lip 24a seals a gap between the door glass 21 and the door frame 13.

In the door glass mounting operation (S140), the slider 22 mounted on the door glass 21 is seated on the inner guide 13a formed on the door frame 13. Since the inner guide 13a is open in the width direction of the vehicle, the door glass 21 is moved from the outside to the inside in the width direction of the vehicle so that the slider 22 mounted on the door glass 21 is seated on the inner guide 13a. Therefore, the door glass 21 may be easily mounted.

After the door glass mounting operation (S140), the garnish assembling operation (S150) of mounting the garnish assembly 27 is performed. The garnish assembly operation (S150) includes assembling the garnish assembly 27 to the door frame 13 so that the garnish assembly 27 finishes the perimeter of the door glass 21 and the outside of the slider 22 is covered with the outer guide 28a formed on the garnish plate 28.

In the garnish assembling operation (S150), the garnish assembly 27 is installed by being moved in the width direction of the vehicle like the door glass 21.

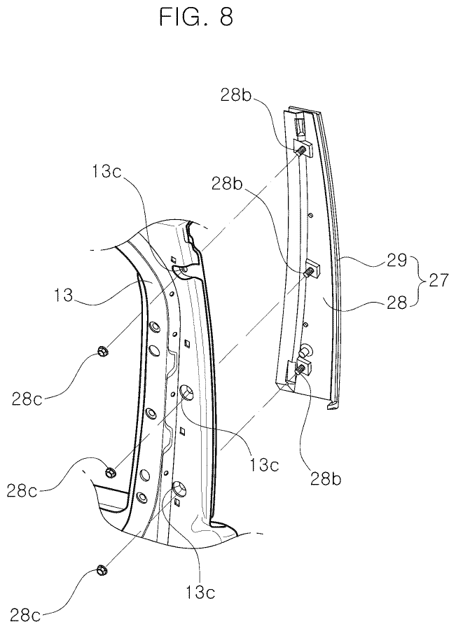

In the garnish assembling operation (S150), the garnish plate 28 is fastened to the door frame 13 using the insert bolt 28b formed on the garnish plate 28. That is, as shown in FIG. 8, the garnish assembly 27 is fastened to the door frame 13 by allowing the insert bolt 28b of the garnish plate 28 to pass through a through-hole 13c of the door frame 13 and then tightening the same using the fastening nut 28c.

What is claimed is:

1. A flush door for a vehicle with a rail integrated door frame, the flush door comprising:
a door frame of the vehicle;
a door glass whose upward and downward movements are guided by the door frame;
a garnish plate fastened to the door frame and configured to guide the upward and downward movements of the door glass together with the door frame; and
a slider fixed to an end portion of the door glass and configured to move up and down between the door frame and the garnish plate.

2. The flush door of claim 1, further comprising an inner guide disposed on the door frame and configured to accommodate the slider.

3. The flush door of claim 2, wherein:
the inner guide is disposed concavely toward an inside of the vehicle and the slider is accommodated therein;
an outer guide configured to cover the slider accommodated in the inner guide is disposed on the garnish plate; and
the outer guide and the inner guide restrict the movement of the slider in a horizontal direction.

4. The flush door of claim 3, wherein the slider comprises:
a body portion configured to move up and down in a height direction of the vehicle between the inner guide and the outer guide; and
a connection portion having a first end fixed to the door glass and a second end fixed to the body portion to connect the door glass with the body portion.

5. The flush door of claim 4, further comprising a locking portion disposed on the door frame convexly outward of the vehicle and configured to restrict the movement of the slider in a longitudinal direction of the vehicle.

6. The flush door of claim 4, further comprising a tension portion configured to elastically support the slider between the slider and the door frame in a state in which the slider moves up or down.

7. The flush door of claim 6, wherein the tension portion comprises:
a first tension portion disposed to protrude from the body portion in a width direction of the vehicle and configured to elastically support the body portion in the width direction; and
a second tension portion disposed to protrude from the body portion in a longitudinal direction of the vehicle and configured to elastically support the body portion in the longitudinal direction.

8. The flush door of claim 1, further comprising an inner panel disposed inside the vehicle on the door frame.

9. The flush door of claim 8, further comprising a vertical beam disposed between the door frame and the inner panel in a vertical direction of the vehicle.

10. The flush door of claim 9, further comprising an inner guide disposed on the door frame and configured to accommodate the slider and a locking portion disposed on the door frame and configured to restrict the movement of the slider in a longitudinal direction of the vehicle, wherein the vertical beam is disposed between the inner panel and the portion where the inner guide and the locking portion formed in the door frame.

11. The flush door of claim 9, wherein the vertical beam is hollow.

12. The flush door of claim 8, further comprising:
an inner cover fixed to an inside of the vehicle in the inner panel; and
a weather strip fixed to the inner panel and configured to seal a gap between the door and a second door disposed in a longitudinal direction of the vehicle.

13. The flush door of claim 1, further comprising an entry portion having a ring shape and disposed at upper and lower ends of the slider in a height direction of the vehicle.

14. The flush door of claim 1, further comprising a garnish cover fastened to an outer surface of the garnish plate and defining a continuous surface with the door glass.

15. The flush door of claim 1, further comprising:
a glass run inner lip fixed to an end portion of the door frame and configured to seal a gap between the door frame and the door glass; and
a glass run outer lip fixed to an end portion of the garnish plate and configured to seal a gap between end portions of the garnish plate and the door glass.

16. The flush door of claim 1, further comprising:
an inner cover fixed to an inside of the vehicle in the door frame; and
a weather strip fixed to the inner cover and configured to seal a gap between the door and a second door disposed in a longitudinal direction of the vehicle.

17. A method of assembling a flush door for a vehicle with a rail integrated door frame, the method comprising:
a door panel temporary assembling operation of assembling a primary door panel assembly by arranging a vertical beam between a door frame and an inner panel and fastening the door frame, the vertical beam, and the inner panel;
a door panel assembly completing operation of completing a door panel assembly by assembling a door outer panel outside the primary door panel assembly;
a door glass mounting operation of mounting a door glass such that a slider mounted on the door glass is seated on an inner guide formed on the door frame; and
a garnish assembling operation of assembling the door frame to a garnish assembly to cover an outside of the slider.

18. The method of claim 17, wherein the door glass mounting operation and the garnish assembling operation each comprise assembling the door glass and the garnish assembly in a width direction of the vehicle.

19. The method of claim 17, further comprising a glass run mounting operation of mounting a glass run inner lip to the door panel assembly between the door panel assembly completing operation and the door glass mounting operation.
